(19) United States
(12) Patent Application Publication
(10) Pub. No.: US 2009/0057441 A1
(43) Pub. Date: Mar. 5, 2009

(54) SPRAY GUN HAVING A NOZZLE DEVICE

(75) Inventor: JUI-MIN CHIANG, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: KUAN CHANG CO., LTD., TAIPEI COUNTY (TW)

(21) Appl. No.: 11/846,059

(22) Filed: Aug. 28, 2007

(51) Int. Cl. B05B 1/28

(52) U.S. Cl. 239/300

(57) ABSTRACT

A spray gun having a nozzle device includes a nozzle base and a nozzle board. The nozzle base is disposed on a spray outlet of the spray gun. The nozzle base includes a pair of upper and lower ledges, a securing member, and a releasing member. An engaging section is formed at the bottom of the lower ledge of the nozzle base. The nozzle board comprises a number of nozzles with different bores in size. Each nozzle corresponds in size to the spray outlet. The securing member is adapted to secure the nozzle board to the nozzle base, and the releasing member is adapted to release the nozzle board from the nozzle base.

### BACKGROUND OF THE INVENTION

1. Field of the Invention

The present invention relates to a spray gun having a nozzle device, and more particularly one having a securing member to secure a nozzle board to the spray gun, and a releasing member to release the nozzle board from the spray gun.

2. Description of the Prior Art

Spray guns are designed to match with nozzles in different sizes to spray paint in different shape for decoration purposes. In a conventional type, each nozzle is formed independently, so that whenever the user wants to replace a different nozzle, he will have to carry them separately. This is inconvenient.

As shown in FIG. 1, a nozzle structure of a spray gun, as disclosed in Taiwanese patent application No. 090209398, comprises a nozzle seat 10 and a nozzle board 20. The nozzle board 20 is provided with a number of nozzles 21 with different bores 211 in size. The nozzle board 20 is inserted onto the nozzle seat 10 and confined thereat. The nozzle seat 10 comprises a pair of channels 12, a through hole 101 at the center and a sleeve 11 protruding from the back of the nozzle seat 10. The sleeve 11 has inner threads 111 for engaging with outer threads provided on the front of a pray gun 3. The upper edge of the nozzle seat 10 is formed with a notch 121. One of the channels 12 of the nozzle seat 10 is provided with an elastic rib 122 which provides a better securing of the nozzle board 20 therein.

Each nozzle 21 provided on the nozzle board 20 has a node 212 corresponding in shape to the notch 121 of the nozzle seat 10 for locating purpose, while a desired nozzle 21 is aligned with the spray outlet 30.

The design was worked perfectly, until a further question arisen when the paint is too thick. The nozzle board 20 may be stuck to the nozzle seat 10, which is hard to remove.

### SUMMARY OF THE INVENTION

According to the present invention, there is provided a spray gun having a nozzle device, comprising a nozzle base disposed on a spray outlet of the spray gun, said nozzle base comprising a pair of upper and lower ledges; a securing member disposed on said upper ledge of said nozzle base; a releasing member disposed on said lower ledge of said nozzle base; an engaging section provided at the bottom of said lower ledge of said nozzle base; and a nozzle board comprising a number of nozzles with different bores in size, each said nozzle corresponding in size to said spray outlet.

### BRIEF DESCRIPTION OF THE DRAWINGS

FIG. 1 is an exploded view of the prior art;

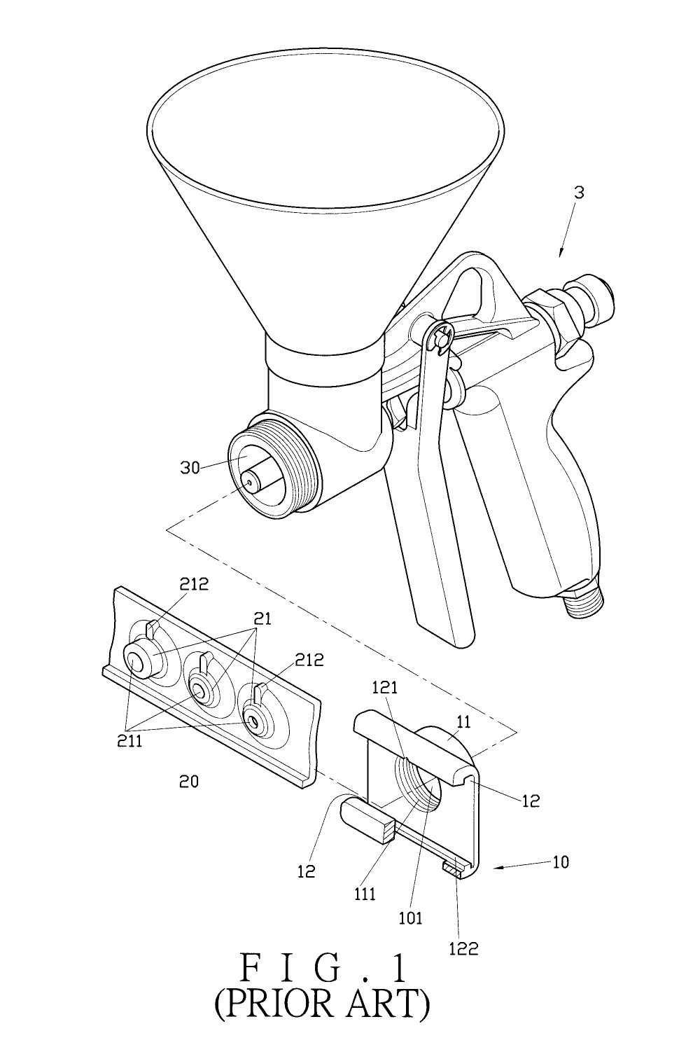

FIG. 2 is an exploded view of a preferred embodiment of the present invention;

FIG. 3 is a perspective view of the preferred embodiment of the present invention; and

FIG. 4 is another perspective view of the preferred embodiment of the present invention.

### DETAILED DESCRIPTION OF THE PREFERRED EMBODIMENT

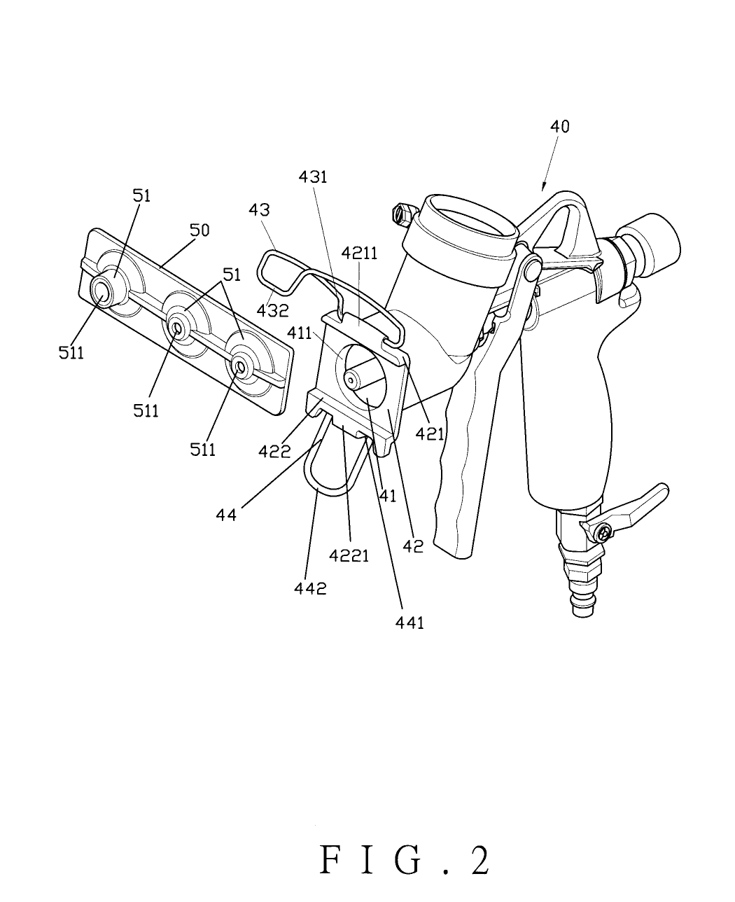

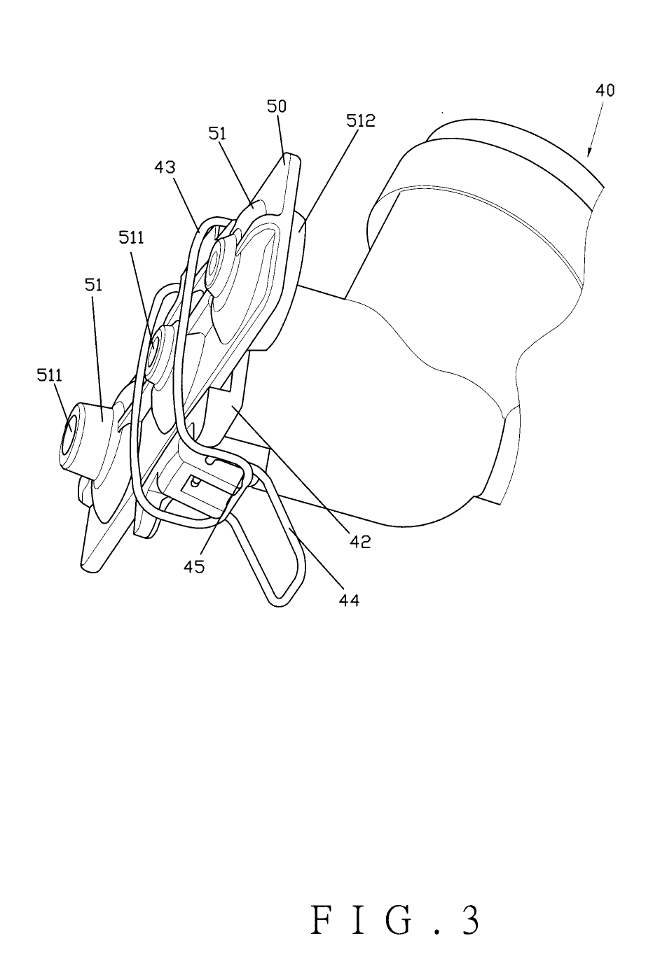

As shown in FIGS. 2 and 3, a preferred embodiment of the present invention comprises a spray gun 40 having a spray outlet 41. A nozzle base 42 having a pair of upper and lower ledges 421 and 422 is provided on the spray outlet 41. An upper lug 4211 is provided on the upper ledge 421, and a lower lug 4221 is provided on the lower ledge 422. A securing member 43 is pivotally connected to the upper lug 4211. A releasing member 44 is pivotally connected to the lower lug 4221. An engaging section 45 is formed at the bottom of the nozzle base 42 toward the direction of the spray body.

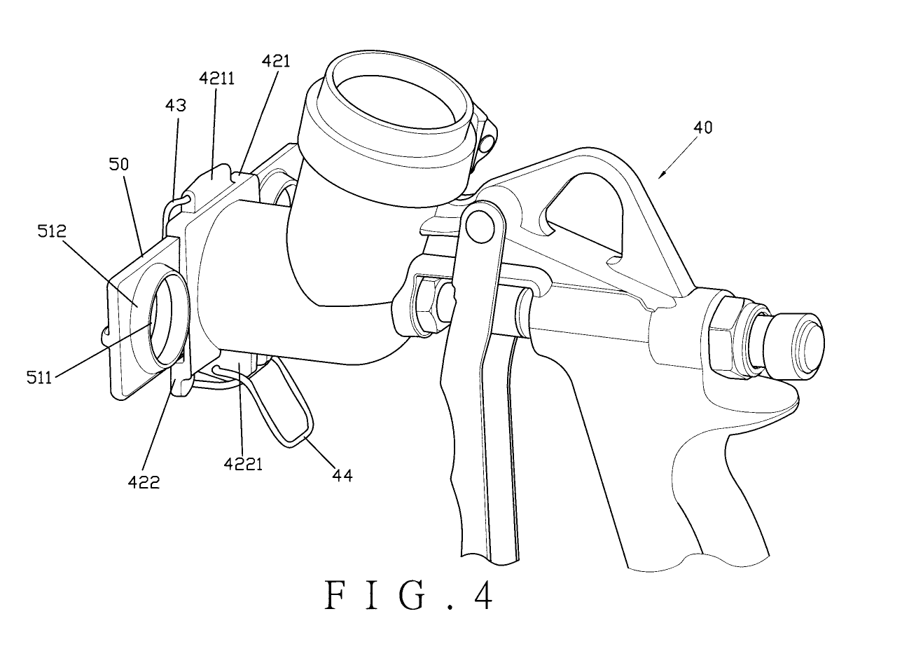

A nozzle board 50 comprises a number of nozzles 51 having different bores 511, such 4.5 mm, 6 mmm, and 8 mm in diameter. The nozzle board 50 is accommodated in the nozzle base 42. The nozzles 51 correspond in shape to the spray outlet 41. A slanting flange 512 is provided on the back of each nozzle 51, as shown in FIG. 4. A slanting surface 411 is formed on the spray outlet 41 for engagement of the slanting flange 512.

The securing member 43, as shown in FIGS. 2 and 4, is made in a hook shape. The securing member 43 has a first end 431 and a second end 432. The first end 431 is pivotally connected to the upper lug 4211. The second end 432 is adapted to engage with the engaging section 45. The releasing member 44 is shaped like an English capital letter U. The releasing member 44 has a first end 441 and a second end 442. The first end 441 is pivotally connected to the lower lug 4221. When the second end 442 of the releasing member 44 is pushed forward, the securing member 43 will be disengaged from the engaging section 45.

To assemble the present invention, the nozzle board 50 is inserted onto the board base 42. A desired nozzle 51 of the nozzle board 50 corresponds in position to the spray outlet 41 of the spray gun 40. The securing member 43 is pushed downward with the second end 432 engaging with the engaging section 45.

To exchange the nozzle 51, the second end 442 of the releasing member 44 is pushed forward, which forces the second end 432 of the securing member 43 to detach from the engaging section 45. Hence, the nozzle board 50 is able to move freely.

What is claimed is:

1. A spray gun having a nozzle device, comprising:
a nozzle base disposed on a spray outlet of the spray gun, said nozzle base comprising a pair of upper and lower ledges;
a securing member disposed on said upper ledge of said nozzle base;
a releasing member disposed on said lower ledge of said nozzle base;
an engaging section provided at the bottom of said lower ledge of said nozzle base; and
a nozzle board comprising a number of nozzles with different bores in size, each said nozzle corresponding in size to said spray outlet.

2. The spray gun having a nozzle device, as recited in claim 1, wherein said spray outlet is formed with a slanting surface and each of said nozzles of said nozzle board is provided with a slanting flange corresponding to said slanting surface of said spray outlet.

3. The spray gun having a nozzle device, as recited in claim 1, wherein said securing member is made in a hook shape and has a first end and a second end, said first end being pivotally connected to an upper lug provided on said upper ledge of said nozzle base, said second end being adapted to engage with said engaging section.

4. The spray gun having a nozzle device, as recited in claim 1, wherein said releasing member has a first end and a second end, said first end being pivotally connected to a lower lug provided on said lower ledge of said nozzle base, said second end being adapted to push said securing member to disengage from said engaging section.
